(19) United States
(12) Patent Application Publication
(10) Pub. No.: US 2026/0283152 A1
(43) Pub. Date: Sep. 24, 2026

(54) SPINOSYN-BASED INSECTICIDAL GRANULE COMPOSITIONS

(71) Applicant: CLARKE MOSQUITO CONTROL PRODUCTS, INC., St. Charles, IL (US)

(72) Inventors: Andrea LEVEY, Naperville, IL (US); Laeticia Leroy Rene-Boisneuf, Naperville, IL (US); Harshapriya Koritala, Lisle, IL (US)

(21) Appl. No.: 19/474,104

(22) PCT Filed: Apr. 10, 2024
(86) PCT No.: PCT/US2024/023872

§ 371 Date: Oct. 9, 2025

Related U.S. Application Data
(60) Provisional application No. 63/495,387, filed on Apr. 11, 2023.

(51) Int. Cl. A01N 43/22; A01P 7/04

(52) U.S. Cl. CPC A01N 43/22; A01P 7/04

(57) ABSTRACT

Exemplary insecticidal compositions may comprise 0.25 weight % (wt %) to 3.50 wt % of a spinosyn-based active ingredient, 65 wt % to 85 wt % of a plaster, 7 wt % to 15 wt % of a polyethylene glycol, and 1 wt % to 15 wt % water. Exemplary insecticidal compositions may be in the form of granules. Exemplary insecticidal compositions may provide an extended release of the spinosyn-based active ingredient over a period of 30 days to 150 days.

### CROSS-REFERENCE TO RELATED APPLICATIONS

This application claims priority to U.S. Provisional Patent Application No. 63/495,387, filed on Apr. 11, 2023, the entire contents of which are incorporated herein by reference.

### TECHNICAL FIELD

The present disclosure relates to insecticidal compositions comprising spinosyn-based active ingredients and methods of making and using the same.

### INTRODUCTION

Various methods may be used to control pests, such as mosquitoes. In some instances, insecticides may be used for pest-control. Insecticides used for pest-control may be formulated for extended release.

### SUMMARY

In one aspect, an insecticidal composition is disclosed. Exemplary insecticidal compositions may comprise 0.25 weight % (wt %) to 3.50 wt % of a spinosyn-based active ingredient; 65 wt % to 85 wt % of a plaster; 7 wt % to 15 wt % of a polyethylene glycol; and 1 wt % to 15 wt % water.

In another aspect, an insecticidal granule is disclosed. Exemplary insecticidal granules may comprise 0.30 weight % (wt %) to 3.00 wt % of a spinosyn-based active ingredient; 70 wt % to 80 wt % of a plaster; 9 wt % to 13 wt % of a polyethylene glycol; and 4 wt % to 12 wt % water.

In another aspect, a method of controlling pests at an application site is disclosed. Exemplary methods of controlling pests may comprise applying exemplary insecticidal granules to the application site.

In another aspect, a method of making an insecticidal granule is disclosed. Exemplary methods of making an insecticidal granule may comprise forming a mixture comprising 0.25 weight % (wt %) to 3.50 wt % of a spinosyn-based active ingredient; 65 wt % to 85 wt % of a plaster; 7 wt % to 15 wt % of a polyethylene glycol; and 1 wt % to 15 wt % water.

In another aspect, a method of using a composition for controlling pests is disclosed. Exemplary methods of using a composition for controlling pests may comprise positioning the composition in a body of water, the composition comprising 0.25 weight % (wt %) to 3.50 wt % of a spinosyn-based active ingredient; 65 wt % to 85 wt % of a plaster; 7 wt % to 15 wt % of a polyethylene glycol; and 1 wt % to 15 wt % water.

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways.

### BRIEF DESCRIPTION OF THE DRAWINGS

FIG. 1 schematically illustrates various exemplary spinosyns derived from the fermentation of Saccharopolyspora spinosa.

FIG. 2 schematically illustrates an exemplary method for preparing exemplary insecticidal granules comprising a spinosyn-based active ingredient. AI=active ingredient %

FIG. 3 graphically shows the 72-hour (hr) efficacy results (percent (%) mortality at 72 hours*) against Aedes aegypti larvae over a 6-week period for three exemplary spinetoram granule prototypes: MBG-1, MBG-2, and MBG-3, which were prepared according to a first lab-scale manufacturing process. *96-hours for week 1.

FIG. 4 graphically shows the 72-hour (hr) efficacy results (percent (%) mortality at 72 hours*) against Culex quinquefasciatus larvae over a 6-week period for three exemplary spinetoram granule prototypes: MBG-1, MBG-2, and MBG-3, which were prepared according to the first lab-scale manufacturing process referenced in FIG. 3. *96-hours for week 1.

FIG. 5 graphically shows the 72-hour (hr) efficacy results (percent (%) mortality at 72 hours*) against Anopheles quadrimaculatus larvae over a 6-week period for three exemplary spinetoram granule prototypes: MBG-1, MBG-2, and MBG-3, which were prepared according to the first lab-scale manufacturing process referenced in FIGS. 3-4. *96-hours for week 1.

FIG. 6 graphically shows the 72-hour (hr) efficacy results (percent (%) mortality at 72-hours*) against Aedes aegypti larvae for three exemplary spinetoram granule prototypes: MBG-1, MBG-2, and MBG-3, which were prepared according to a second lab-scale manufacturing process. *96-hours for week 1.

FIG. 7 graphically shows the 72-hour (hr) efficacy results (percent (%) mortality at 72-hours*) against Culex quinquefasciatus larvae over a 6-week period for three exemplary spinetoram granule prototypes: MBG-1, MBG-2, and MBG-3, which were prepared according to the second lab-scale manufacturing process referenced in FIG. 6. *96-hours for week 1.

FIG. 8 graphically shows the 72-hour (hr) efficacy results (percent (%) mortality at 72-hours*) against Anopheles quadrimaculatus larvae over a 6-week period for three exemplary spinetoram granule prototypes: MBG-1, MBG-2, and MBG-3, which were prepared according to the second lab-scale manufacturing process referenced in FIGS. 6-7. *96-hours for week 1.

FIG. 9 is a photograph showing exemplary experimental insecticidal granules prepared with an exemplary metal stearate (right) and exemplary experimental insecticidal granules prepared without a metal stearate (left).

### DETAILED DESCRIPTION

Compositions, methods, and techniques disclosed and contemplated herein relate to insecticidal compositions. Exemplary insecticidal compositions may be designed as formulations that release spinosyn-based active ingredient over an extended period of time. Exemplary insecticidal compositions may comprise 0.25 weight % (wt %) to 3.50 wt % of a spinosyn-based active ingredient. Exemplary insecticidal compositions may be in the form of a granule. Exemplary granules may be in the form of a pellet.

### I. DEFINITIONS

Unless otherwise defined, all technical and scientific terms used herein have the same meaning as commonly understood by one of ordinary skill in the art. In case of conflict, the present document, including definitions, will control. Methods and materials are described below, although methods and materials similar or equivalent to those described herein can be used in practice or testing of the present disclosure. All publications, patent applications, patents and other references mentioned herein are incorporated by reference in their entirety. The materials, methods, and examples disclosed herein are illustrative only and not intended to be limiting.

The terms “comprise(s),” “include(s),” “having,” “has,” “can,” “contain(s),” and variants thereof, as used herein, are intended to be open-ended transitional phrases, terms, or words that do not preclude the possibility of additional acts or structures. The singular forms “a,” “an” and “the” include plural references unless the context clearly dictates otherwise. The present disclosure also contemplates other embodiments “comprising,” “consisting of” and “consisting essentially of,” the embodiments or elements presented herein, whether explicitly set forth or not.

As used herein, the term “about” is used to indicate that exact values are not necessarily attainable. Therefore, the term “about” is used to indicate this uncertainty limit. The term “about” may refer to plus or minus 10% of the indicated number. For example, “about 10%” may indicate a range of 9% to 11%, and “about 1” may mean from 0.9-1.1. Other meanings of “about” may be apparent from the context, such as rounding off, so, for example “about 1” may also mean from 0.5-1.4. The modifier “about” should also be considered as disclosing the range defined by the absolute values of the two endpoints. For example, the expression “from about 2 to about 4” also discloses the range “from 2 to 4.”

For the recitation of numeric ranges herein, each intervening number there between with the same degree of precision is contemplated. For example, for the range of 6-9, the numbers 7 and 8 are contemplated in addition to 6 and 9, and for the range 6.0-7.0, the numbers 6.0, 6.1, 6.2, 6.3, 6.4, 6.5, 6.6, 6.7, 6.8, 6.9, and 7.0 are contemplated. For another example, when a pressure range is described as being between ambient pressure and another pressure, a pressure that is ambient pressure is expressly contemplated.

Definitions of specific functional groups and chemical terms are described in more detail below. For purposes of this disclosure, the chemical elements are identified in accordance with the Periodic Table of the Elements, CAS version, Handbook of Chemistry and Physics, 75^{th} Ed., inside cover, and specific functional groups are generally defined as described therein. Additionally, general principles of organic chemistry, as well as specific functional moieties and reactivity, are described in Organic Chemistry, Thomas Sorrell, University Science Books, Sausalito, 1999; Smith and March March's Advanced Organic Chemistry, 5^{th} Edition, John Wiley & Sons, Inc., New York, 2001; Larock, Comprehensive Organic Transformations, VCH Publishers, Inc., New York, 1989; Carruthers, Some Modern Methods of Organic Synthesis, 3^{rd} Edition, Cambridge University Press, Cambridge, 1987; the entire contents of each of which are incorporated herein by reference.

The term “alkyl” means a straight or branched chain hydrocarbon. The term “C₁₋₄ alkyl” means a straight or branched chain hydrocarbon containing from 1 to 4 carbon atoms. Representative examples of alkyl include, but are not limited to, methyl, ethyl, n-propyl, iso-propyl, n-butyl, sec-butyl, iso-butyl, tert-butyl, n-pentyl, isopentyl, neopentyl, n-hexyl, 3-methylhexyl, 2,2-dimethylpentyl, 2,3-dimethylpentyl, n-heptyl, n-octyl, n-nonyl, and n-decyl.

The term “alkyl” may be preceded by a designation indicating the number of atoms present in the group in a particular instance (e.g., “C₁₋₄ alkyl,”). These designations are used as generally understood by those skilled in the art. For example, the representation “C” followed by a subscripted number indicates the number of carbon atoms present in the group that follows. Thus, “C₃ alkyl” is an alkyl group with three carbon atoms (i.e., n-propyl, isopropyl). Where a range is given, as in “C₁₋₄,” the members of the group that follows may have any number of carbon atoms falling within the recited range. A “C₁₋₄alkyl,” for example, is an alkyl group having from 1 to 4 carbon atoms, however arranged (i.e., straight chain or branched).

The term “halogen” or “halo,” as used herein, means chlorine (Cl), bromine (Br), iodine (I), or fluorine (F).

The term “haloalkyl,” as used herein, means an alkyl group, as defined herein, in which one, two, three, four, five, six, seven or eight hydrogen atoms are replaced by a halogen.

The term “hydroxyl” or “hydroxy,” as used herein, means an —OH group.

The term “amino,” as used herein, means a —NH₂ group.

The term “protecting group,” as used herein refers to a moiety that when attached to a reactive group in a molecule masks, reduces, or prevents that reactivity. Suitable protecting groups and the methods for protecting and deprotecting different substituents using such suitable protecting groups are well known to those skilled in the art. Examples may be found in PGM Wuts and TW Greenes' book titled Protective Groups in Organic Synthesis (4^{th} ed.), John Wiley & Sons, NY (2006), which is incorporated herein by reference in its entirety.

The term “saccharide” refers to any type of hexose of the formula C₆H₁₂O₆ or a derivative thereof.

### II. COMPOSITIONS

Exemplary insecticidal compositions may include various components at differing amounts. Exemplary insecticidal compositions may be formulated to release the spinosyn-based active ingredient over an extended period. Various aspects of exemplary insecticidal compositions are discussed below.

### A. Various Components of Exemplary Insecticidal Compositions

Exemplary insecticidal compositions include an active ingredient and various support components. Broadly, exemplary active ingredients may be spinosyn-based active ingredients.

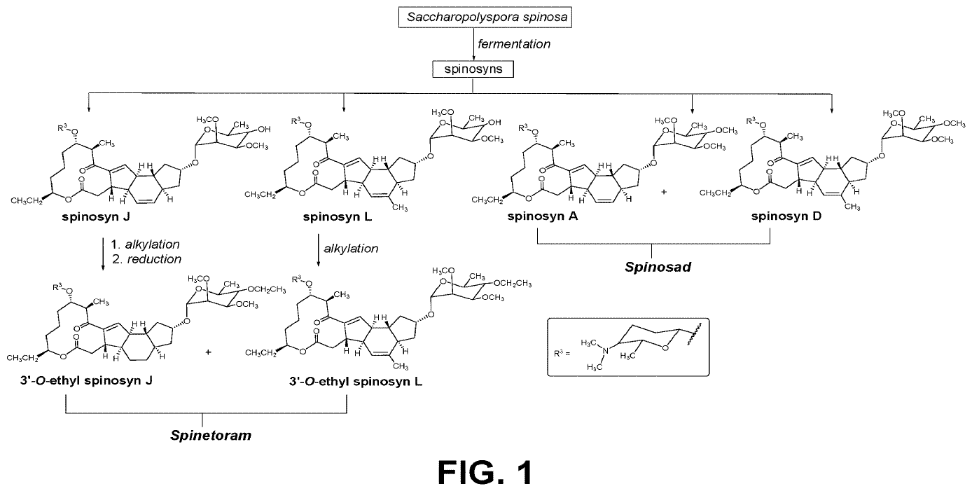

Exemplary spinosyn-based active ingredients may comprise one or more spinosyns. Spinosyns are compounds having a polyketide-derived tetracyclic macrolide core that may be derived from the fermentation of Saccharopolyspora's soil actinomycetes species. Exemplary Saccharopolyspora soil actinomycetes species include the Saccharopolyspora spinosa species. As schematically illustrated in FIG. 1, various exemplary spinosyns may be derived from the Saccharopolyspora spinosa species and its fermentation products.

In various instances, exemplary spinosyn-based active ingredients may include a spinosyn, wherein the polyketide-derived tetracyclic macrolide core is attached to a saccharide moiety. For example, in various instances, exemplary spinosyn-based active ingredients may include one or more spinosyns of formula (I),

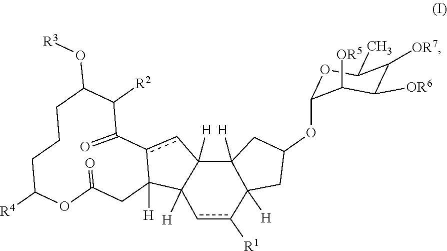

wherein:
[symbol] is a double or a single bond;
R¹ is hydrogen or methyl;
R² is hydrogen or C₁₋₄alkyl;
R³ is

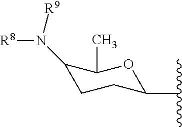

or hydrogen;
R⁴ is methyl or ethyl;
R⁵, R⁶, and R⁷ are each independently hydrogen, C₁₋₄alkyl, C₁₋₄haloalkyl,

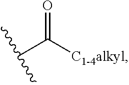

or a hydroxyl protecting group; and
R⁸ and R⁹, at each occurrence, are each independently hydrogen, C₁₋₄alkyl, C₁₋₄haloalkyl,

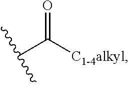

or an amino protecting group.

Exemplary hydroxyl protecting groups may include acyl groups, benzyl ethers, trityl ethers, tetrahydropyranyl ethers, trialkylsilyl ethers, and allyl ethers. Exemplary amino protecting groups may include formyl, acetyl groups, trifluoroacetyl groups, benzyl groups, benzyloxycarbonyl (CBZ), tert-butoxycarbonyl (Boe), trimethyl silyl (TMS), 2-trimethylsilyl-ethanesulfonyl (SES), trityl-based groups, allyloxycarbonyl groups, 9-fluorenylmethyloxycarbo-nyl (FMOC), and nitro-veratryloxycarbonyl (NV OC).

In various instances, the spinosyn-based active ingredient may include one or more of spinosyn A, spinosyn B, spinosyn C, spinosyn D, spinosyn E, spinosyn F, spinosyn G, spinosyn H, spinosyn I, spinosyn J, spinosyn K, spinosyn L, spinosyn M, spinosyn N, spinosyn O, spinosyn P, spinosyn Q, spinosyn R, spinosyn S, spinosyn T, spinosyn U, spinosyn V, spinosyn W, spinosyn X, spinosyn Y, and/or a derivative thereof.

Exemplary spinosyn-based active ingredients may include naturally occurring spinosyns, synthetic spinosyns, and combinations thereof. In various instances, the synthetic spinosyn may be a spinosyn that is prepared via semisynthesis (a “semisynthetic spinosyn”). The term “semisynthesis,” as used herein, means a chemical synthesis that uses compounds isolated from natural sources as the starting materials from which the products are synthesized. In various instances, exemplary naturally occurring spinosyns may be the starting materials for preparing various exemplary semisynthetic spinosyns. For example, shown in FIG. 1, naturally occurring spinosyns J and L, obtained by fermenting Saccharopolyspora spinosa, may be synthetically modified to provide the exemplary semisynthetic spinosyns 3-O-ethyl spinosyn J and 3-O-ethyl spinosyn L, respectively.

In various instances, the spinosyn-based active ingredient may comprise spinetoram. Spinetoram is a commercially available, semisynthetic spinosyn-based active ingredient derived from the fermentation products of actinobacterium species Saccharopolyspora spinosa, as shown in FIG. 1. Specifically, spinetoram (CAS No.: 935545-74-7) is a mixture of the two semisynthetic spinosyns 3′-O-ethyl spinosyn J (CAS No.: 187166-40-1) and 3′-O-ethyl spinosyn L (CAS No.: 187166-15-0), shown below.

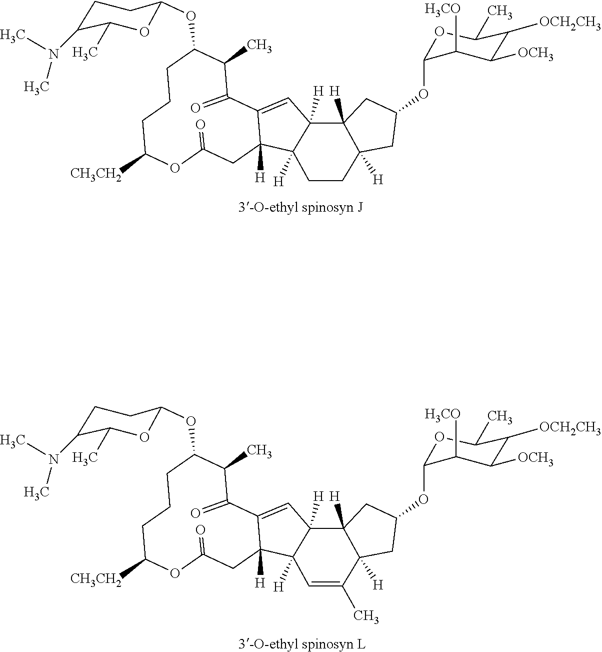

The two components of spinetoram, 3′-O-ethyl spinosyn J and 3′-O-ethyl spinosyn L, may be present in varying weight ratios. In various instances, the weight ratio of 3′-O-ethyl spinosyn J to 3′-O-ethyl spinosyn L in spinetoram may range from 1:1 to 9:1. In various instances, the weight ratio of 3′-O-ethyl spinosyn J to 3′-O-ethyl spinosyn L may range from 2:1 to 8:1; 3:1 to 7:1 or 4:1 to 6:1. In various instances the weight ratio of 3′-O-ethyl spinosyn J to 3′-O-ethyl spinosyn L may be no greater than 9:1; no greater than 8:1; no greater than 7:1; no greater than 6:1; no greater than 5:1; no greater than 4:1; no greater than 3:1; no greater than 2:1; or no greater than 1:1. In various instances the weight ratio of 3′-O-ethyl spinosyn J to 3′-O-ethyl spinosyn L may be no less than 1:1; no less than 2:1; no less than 3:1; no less than 4:1; no less than 5:1; no less than 6:1; no less than 7:1; no less than 8:1; or no less than 9:1.

In various instances, the spinosyn-based active ingredient may comprise spinosad. Spinosad (CAS No.: 168316-95-8) is a commercially available, naturally occurring fermentation product of the actinobacterium species Saccharopolyspora spinosa, as illustrated in FIG. 1. Specifically, spinosad is a mixture of the two naturally occurring spinosyns spinosyn A and spinosyn D, shown below.

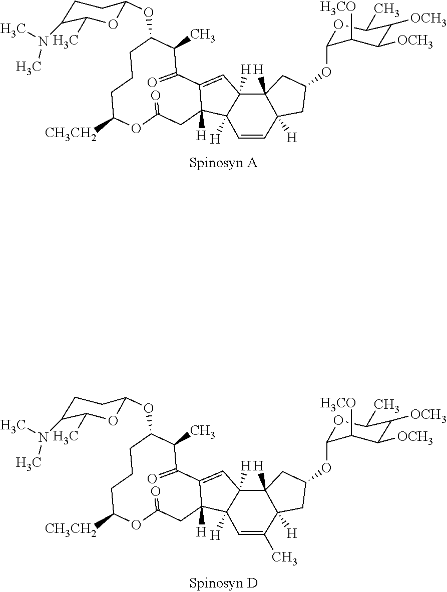

The two components of spinosad, spinosyn A and spinosyn D, may be present in varying weight ratios. In various instances, the weight ratio of spinosyn A to spinosyn D may range from 4:1 to 50:1. In some instances, the weight ratio of spinosyn A to spinosyn D may range from 5:1 to 45:1; 10:1 to 40:1; 15:1 to 35:1; 20:1 to 30:1; or 22:1 to 28:1. In various instances, the weight ratio of spinosyn A to spinosyn D may be no greater than 50:1; no greater than 45:1; no greater than 40:1; no greater than 35:1; no greater than 30:1; no greater than 25:1; no greater than 20:1; no greater than 15:1; no greater than 10:1; or no greater than 5:1. In various instances, the weight ratio of spinosyn A to spinosyn D may be no less 4:1; no less than 5:1; no less than 10:1; no less than 15:1; no less than 20:1; no less than 25:1; no less than 30:1; no less than 35:1; no less than 40:1; or no less than 45:1.

An exemplary commercially available spinosad is Spinosad NT (available from Corteva, Inc., Indianapolis, Indiana). Spinosad NT contains a mixture of the active ingredients spinosyn A (CAS No.: 131929-60-7) and spinosyn D (CAS No.: 131929-63-0) at a total nominal concentration of 90.4%. Spinosad NT has been shown to be highly effective against a wide variety of insects including species from the orders Coleoptera, Diptera, Hymenoptera, Lepidoptera, and Thysanoptera.

Exemplary insecticidal compositions may further comprise support components. Exemplary support components may include at least one of: a plaster, a water-soluble binder, and water. In various instances, the water may be tap water. In some instances, the water may be treated with water softener salt. In some instances, exemplary support components may optionally further include a wax and/or a gum. In some instances, exemplary compositions may optionally include one or more metal stearates.

Exemplary plasters may include a plaster of Paris, lime plaster, cement plaster, and combinations thereof. In various instances, exemplary plasters may include one or more commercially available plasters. Exemplary commercially available plasters may include Terra Alba, Snow White Filler, Puritan Pottery Plaster, No. 1 Molding Plaster, No. 2 Molding Plaster, Duramold Pottery Plaster, C-Base Plaster, Hydrocal A-11, Hydrocal B-11, Hydrocal X-21, Hydrocal MC, No. 1 Casting Plaster, Dental Plaster, Casting Plaster, Potting Plaster, Ultracal 30 Gypsum Cement, Ultracal 60 Gypsum Cement (all available from United States Gypsum), and combinations thereof. In various instances, the plaster may be a plaster of Paris.

Exemplary water-soluble binders may include polyethylene glycols (PEGs) of varying molecular weights. In various instances, exemplary polyethylene glycols may include polyethylene glycols with molecular weights in the range from about 1000 to about 8500, which include Carbowax 3350, Carbowax 4000, Carbowax 6000, Carbowax 8000, and combinations thereof.

Exemplary PEGs may have a molecular weight (MW) of 7500 to 8500 g/mol. In various instances, the PEG may have a MW of 7600 to 8400 g/mol; 7700 to 8300 g/mol; 7800 to 8200 g/mol; or 7900 to 8100 g/mol. In various instances, the PEG may have a MW of no greater than 8500 g/mol; no greater than 8400 g/mol; no greater than 8300 g/mol; no greater than 8200 g/mol; no greater than 8100 g/mol; no greater than 8000 g/mol; no greater than 7900 g/mol; no greater than 7800 g/mol; no greater than 7700 g/mol; no greater than 7600 g/mol; or no greater than 7500 g/mol. In various instances, the PEG may have a MW of no less than 8500 g/mol; no less than 8400 g/mol; no less than 8300 g/mol; no less than 8200 g/mol; no less than 8100 g/mol; no less than 8000 g/mol; no less than 7900 g/mol; no less than 7800 g/mol; no less than 7700 g/mol; no less than 7600 g/mol; or no less than 7500 g/mol.

Various waxes and/or gums may be optionally included in exemplary insecticidal compositions. Exemplary waxes may include carnauba wax. Exemplary gums may include xanthan gum.

Various metal stearates may be optionally included in exemplary insecticidal compositions. In various instances, exemplary metal stearates may include aluminum stearate, calcium stearate, magnesium stearate, potassium stearate, sodium stearate, and zinc stearate, and combinations thereof. In some implementations, the metal stearate may be magnesium stearate.

### B. Amounts of Various Components of Exemplary Insecticidal Compositions

Exemplary insecticidal compositions may include various amounts of various components. Example constituents and possible amounts are provided below.

Exemplary insecticidal compositions may include a spinosyn-based active ingredient at 0.25 weight % (wt %) to 3.50 wt %. In various instances, exemplary insecticidal compositions may include a spinosyn-based active ingredient at 0.26 wt % to 3.40 wt %; 0.27 wt % to 3.30 wt %; 0.28 wt % to 3.20 wt %; 0.29 wt % to 3.10 wt %; 0.30 wt % to 3.00 wt %; 0.33 wt % to 2.70 wt %; 0.35 wt % to 2.50 wt %; 0.38 wt % to 2.20 wt %; 0.40 wt % to 1.00 wt %; 0.45 wt % to 0.95 wt %; 0.45 wt % to 0.95 wt %; 0.50 wt % to 0.90 wt %; 0.55 wt % to 0.85 wt %; 0.60 wt % to 0.80 wt %; or 0.65 wt % to 0.75 wt %. In various instances, exemplary insecticidal compositions may include a spinosyn-based active ingredient at no greater than 3.50 wt %; no greater than 3.30 wt %; no greater than 3.00 wt %; no greater than 2.80 wt %; no greater than 2.50 wt %; no greater than 2.30 wt %; no greater than 2.00 wt %; no greater than 1.80 wt %; no greater than 1.50 wt %; no greater than 1.30 wt %; no greater than 1.00 wt %; no greater than 0.90 wt %; no greater than 0.80 wt %; no greater than 0.70 wt %; no greater than 0.60 wt %; no greater than 0.50 wt %; no greater than 0.40 wt %; or no greater than 0.30 wt %. In various instances, exemplary insecticidal compositions may include a spinosyn-based active ingredient at no less than 0.25 wt %; no less than 0.27 wt %; no less than 0.30 wt % no less than 0.60 wt %; no less than 0.70 wt %; no less than 0.80 wt %; no less than 0.90 wt %; no less than 1.00 wt %; no less than 1.20 wt %; no less than 1.50 wt %; no less than 1.70 wt %; no less than 2.00 wt %; no less than 2.20 wt %; no less than 2.50 wt %; no less than 2.70 wt %; no less than 3.00 wt %; no less than 3.20 wt %; or no less than 3.40 wt %.

Exemplary insecticidal compositions may include a plaster at 65 wt % to 85 wt %. In various instances, exemplary insecticidal compositions may comprise a plaster at 66 wt % to 84 wt %; 67 wt % to 83 wt %; 68 wt % to 82 wt % 69 wt % to 81 wt %; 70 wt % to 80 wt %; 71 wt % to 79 wt %; 72 wt % to 78 wt %; 73 wt % to 79 wt %; or 74 wt % to 76 wt %. In various instances, a total amount of a plaster in exemplary insecticidal compositions may be no greater than 85 wt %; no greater than 84 wt %; no greater than 83 wt %; no greater than 82 wt %; no greater than 81 wt %; no greater than 80 wt %; no greater than 79 wt %; no greater than 78 wt %; no greater than 77 wt %; no greater than 76 wt %; no greater than 75 wt %; no greater than 74 wt %; no greater than 73 wt %; no greater than 72 wt %; no greater than 71 wt %; no greater than 70 wt %; no greater than 69 wt %; no greater than 68 wt %; no greater than 67 wt %; or no greater than 66 wt %. In various instances, a total amount of a plaster in exemplary insecticidal compositions may be no less than 65 wt %; no less than 66 wt %; no less than 67 wt %; no less than 68 wt %; no less than 69 wt %; no less than 70 wt %; no less than 71 wt %; no less than 72 wt %; no less than 73 wt %; no less than 74 wt %; no less than 75 wt %; no less than 76 wt %; no less than 77 wt %; no less than 78 wt %; no less than 79 wt %; no less than 80 wt %; no less than 81 wt %; no less than 82 wt %; no less than 83 wt %; or no less than 84 wt %.

Exemplary insecticidal compositions may include a polyethylene glycol at 7 wt % to 15 wt %. In various instances, a total amount of a polyethylene glycol in exemplary insecticidal compositions may be 7.5 wt % to 14.5 wt %; 8 wt % to 14 wt %; 8.5 wt % to 13.5 wt %; 9 wt % to 13 wt %; 10 wt % to 12 wt %; or 10.5 wt % to 11.5 wt %. In various instances, a total amount of a water-soluble binder in exemplary insecticidal compositions may be no greater than 15 wt %; no greater than 14 wt %; no greater than 13 wt %; no greater than 12 wt %; no greater than 11 wt %; no greater than 10 wt %; no greater than 9 wt %; or no greater than 8 wt %. In various instances, a total amount of a water-soluble binder in exemplary insecticidal compositions may be no less than 7 wt %; no less than 8 wt %; no less than 9 wt %; no less than 10 wt %; no less than 11 wt %; no less than 12 wt %; no less than 13 wt %; or no less than 14 wt %.

Exemplary insecticidal compositions may include water at 1 wt % to 15 wt %. In various instances, exemplary insecticidal compositions may comprise water at 2 wt % to 14 wt %; 3 wt % to 13 wt %; 4 wt % to 12 wt %; 5 wt % to 11 wt %; 6 wt % to 10 wt %; or 7 wt % to 9 wt %. In various instances, exemplary insecticidal compositions may comprise water at no greater than 15 wt %; no greater than 14 wt %; no greater than 13 wt %; no greater than 12 wt %; no greater than 11 wt %; no greater than 10 wt %; no greater than 9 wt %; no greater than 8 wt %; no greater than 7 wt %; no greater than 6 wt %; no greater than 5 wt %; no greater than 4 wt %; no greater than 3 wt %; or no greater than 2 wt %. In various instances, exemplary insecticidal compositions may comprise water at no less than 1 wt %; no less than 2 wt %; no less than 3 wt %; no less than 4 wt %; no less than 5 wt %; no less than 6 wt %; no less than 7 wt % no less than 8 wt %; no less than 9 wt %; no less than 10 wt %; no less than 11 wt %; no less than 12 wt %; no less than 13 wt; or no less than 14 wt %%.

In various instances, exemplary insecticidal compositions may optionally comprise a wax and/or a gum. In those implementations, exemplary insecticidal compositions may comprise a wax and/or a gum at 1 wt % to 5 wt %. In some instances, exemplary insecticidal compositions may comprise a wax and/or a gum at 1.25 wt % to 4.75 wt %; 1.5 wt % to 4.5 wt %; 1.75 wt % to 4.75 wt %; 2 wt % to 4 wt %; 2.25 wt % to 3.75 wt %; or 2.5 wt % to 3.5 wt %. In some instances, exemplary insecticidal compositions may comprise a wax and/or a gum at no greater than 5 wt %; no greater than 4.5 wt %; no greater than 4.0 wt %; no greater than 3.5 wt %; no greater than 3.0 wt %; no greater than 2.5 wt %; no greater than 2.0 wt %; or no greater than 1.5 wt %. In some instances, exemplary insecticidal compositions may comprise a wax and/or a gum at no less than 1 wt %; no less than 1.5 wt %; no less than 2 wt %; no less than 2.5 wt %; no less than 3 wt %; no less than 3.5 wt %; or no less than 4 wt %.

In various instances, exemplary insecticidal compositions may optionally comprise a metal stearate. In those implementations, exemplary insecticidal compositions may comprise metal stearate at 0.10 wt % to 1.0 wt %. In some instances, exemplary insecticidal compositions may comprise a metal stearate at 0.15 wt % to 0.95 wt %; 0.20 wt % to 0.90 wt %; 0.25 wt % to 0.85 wt %; 0.30 wt % to 0.80 wt %; 0.35 wt % to 0.75 wt %; 0.30 wt % to 0.80 wt %; 0.35 wt % to 0.75 wt %; 0.40 wt % to 0.70 wt %; 0.45 wt % to 0.65 wt %; or 0.50 wt % to 0.60 wt %. In some instances, exemplary insecticidal compositions may comprise a metal stearate at no greater than 1 wt %; no greater than 0.90 wt %; no greater than 0.80 wt %; no greater than 0.70 wt %; no greater than 0.60 wt %; no greater than 0.50 wt %; no greater than 0.40 wt %; no greater than 0.30 wt %; no greater than 0.20 wt %; or no greater than 0.15 wt %. In some instances, exemplary insecticidal compositions may comprise a metal stearate at no less than 0.10 wt %; no less than 0.20 wt %; no less than 0.30 wt %; no less than 0.40 wt %; no less than 0.50 wt %; no less than 0.60 wt %; no less than 0.70 wt %; no less than 0.80 wt %; no less than 0.90 wt %; or no less than 0.95 wt %.

### C. Exemplary Insecticidal Granule Properties

Exemplary insecticidal compositions may be in the form of a granule (i.e., “an insecticidal granule”). As used herein, “granule” forms include solid forms or shapes known in the art such as pellets, beads, spheres, and the like. In various instances, the insecticidal granule may be in the form of a pellet. Exemplary granules may have a release profile enabling release of active ingredient over a period. Exemplary insecticidal granules may be single-layered granules.

In various instances, exemplary insecticidal granules may be formulated so that the active ingredient is encapsulated within a matrix comprising various support components. As described above, exemplary support components may include a plaster and/or a water-soluble binder. Upon applying the insecticidal granules to an application site, the matrix may dissolve over a period of time, thereby continuously releasing the active ingredient over the period of time. Various physical characteristics of exemplary granules are discussed below.

Exemplary insecticidal granules may have various sizes. In various instances, exemplary insecticidal granules may have an average diameter of 1.4 millimeters (mm) to 3.4 mm. In various instances, exemplary insecticidal granules may have an average diameter of 1.5 mm to 3.3 mm; 1.6 mm to 3.2 mm; 1.7 mm to 3.1 mm; 1.8 mm to 3.0 mm; 1.9 mm to 2.9 mm; 2.0 mm to 2.8 mm; 2.1 mm to 2.7 mm, 2.2 mm to 2.6 mm, or 2.3 mm to 2.5 mm. In various instances, exemplary insecticidal granules may have an average diameter of no greater than 3.4 mm; no greater than 3.2 mm; no greater than 3.0 mm; no greater than 2.8 mm; no greater than 2.6 mm; no greater than 2.4 mm; no greater than 2.2 mm; no greater than 2.0 mm; no greater than 1.8 mm; no greater than 1.6 mm; or no greater than 1.4 mm. In various instances, exemplary insecticidal granules may have an average diameter of no less than 1.4 mm; no less than 1.6 mm; no less than 1.8 mm; no less than 2.0 mm; no less than 2.2 mm; no less than 2.4 mm; no less than 2.6 mm; no less than 2.8 mm; no less than 3.0 mm; no less than 3.2 mm; or no less than 3.4 mm.

In various instances, 75% to 85% of the exemplary insecticidal granules may have an average diameter of 2.4 mm to 3.4 mm. In various instances, 75% to 85% of the of the exemplary insecticidal granules may have an average diameter of 2.5 mm to 3.4 mm; 2.5 mm to 3.3 mm; 2.6 mm to 3.3 mm; 2.6 mm to 3.2 mm; 2.7 mm to 3.2 mm; 2.7 mm to 3.1 mm; 2.8 mm to 3.1 mm; or 2.8 mm to 3.0 mm. In various instances, 75% to 85% of the of the exemplary insecticidal granules may have an average diameter of no greater than 3.4 mm; no greater than 3.2 mm; no greater than 3.1 mm; no greater than 3.0 mm; no greater than 2.9 mm; no greater than 2.8 mm; no greater than 2.7 mm; no greater than 2.6 mm; no greater than 2.5 mm; or no greater than 2.4 mm. In various instances, 75% to 85% of the of the exemplary insecticidal granules may have an average diameter of no less than 2.4 mm; no less than 2.5 mm; no less than 2.6 mm; no less than 2.7 mm; no less than 2.8 mm; no less than 2.9 mm; no less than 3.0 mm; no less than 3.1 mm; no less than 3.2 mm; no less than 3.3 mm; or no less than 3.4 mm.

Exemplary insecticidal granules may have various pour densities. In various instances, exemplary insecticidal granules may have a pour density of 880 to 1360 kilograms per cubic meter (kg/m³). In various instances, exemplary insecticidal granules may have a pour density of 900 to 1350 kg/m³; 910 to 1330 kg/m³; 930 to 1310 kg/m³; 950 to 1300 kg/m³; 960 to 1280 kg/m³; 980 to 1270 kg/m³; 990 to 1250 kg/m³; 1010 to 1230 kg/m³; 1030 to 1220 kg/m³; 1040 to 1200 kg/m³; 1060 to 1170 kg/m³; 1070 to 1120 kg/m³; or 1080 to 1100 kg/m³. In various instances, exemplary insecticidal granules may have a pour density of no greater than 1360 kg/m³; no greater than 1330 kg/m³; no greater than 1280 kg/m³; no greater than 1250 kg/m³; no greater than 1200 kg/m³; no greater than 1170 kg/m³; no greater than 1120 kg/m³; no greater than 1090 kg/m³; no greater than 1040 kg/m³; no greater than 1010 kg/m³; no greater than 960 kg/m³; no greater than 930 kg/m³; or no greater than 900 kg/m³. In various instances, exemplary insecticidal granules may have a pour density of no less than 880 kg/m³; no less than 910 kg/m³; no less than 960 kg/m³; no less than 990 kg/m³; no less than 1040 kg/m³; no less than 1070 kg/m³; no less than 1100 kg/m³; no less than 1120 kg/m³; no less than 1150 kg/m³; no less than 1250 kg/m³; no less than 1200 kg/m³; no less than 1230 kg/m³; no less than 1280 kg/m³; no less than 1310 kg/m³; or no less than 1330 kg/m³.

Exemplary insecticidal granules may have various surface areas. In various instances, exemplary insecticidal granules may have a surface area between 6 mm² and 30 mm². In various instances, exemplary insecticidal granules may have a surface area between 7 mm² and 29 mm²; 8 mm² and 28 mm²; 9 mm² and 27 mm²; 10 mm² and 25 mm²; 12 mm² and 23 mm²; 13 mm² and 21 mm²; 15 mm² and 20 mm²; or 16 mm² and 19 mm². In various instances, exemplary insecticidal granules may have a surface area of no greater than 30 mm²; no greater than 29 mm²; no greater than 27 mm²; no greater than 25 mm²; no greater than 22 mm²; no greater than 20 mm²; no greater than 18 mm²; no greater than 15 mm²; no greater than 13 mm²; no greater than 10 mm²; or no greater than 8 mm². In various instances, exemplary insecticidal granules may have a surface area of no less than 6 mm²; no less than 8 mm²; no less than 10 mm²; no less than 13 mm²; no less than 15 mm²; no less than 18 mm²; no less than 20 mm²; no less than 22 mm²; no less than 25 mm²; no less than 27 mm²; or no less than 29 mm².

Exemplary insecticidal granules may be further characterized by their dustiness. The term “dustiness,” as used herein, means the tendency of particles to become airborne in response to a mechanical or aerodynamic stimulus. Dustiness may be measured by collecting and measuring the “attrition,” from the amount of airborne dust in a chamber in which granules have fallen. In some instances, dustiness may be determined by following the International Pesticides Analytical Council (CIPAC)'s MT method 58, entitled “Dust Content and Apparent Density of Granular Pesticide Formulations.” In various instances, exemplary insecticidal granules may have an attrition of less than 3 wt %. In some instances, exemplary granules may have an attrition of less than 2.5 wt %; less than 2 wt %; less than 1.5 wt %; or less than 0.5 wt %.

### III. EXEMPLARY METHODS OF MAKING EXEMPLARY INSECTICIDAL COMPOSITIONS

Exemplary insecticidal compositions disclosed and contemplated herein may be generally prepared by various exemplary methods.

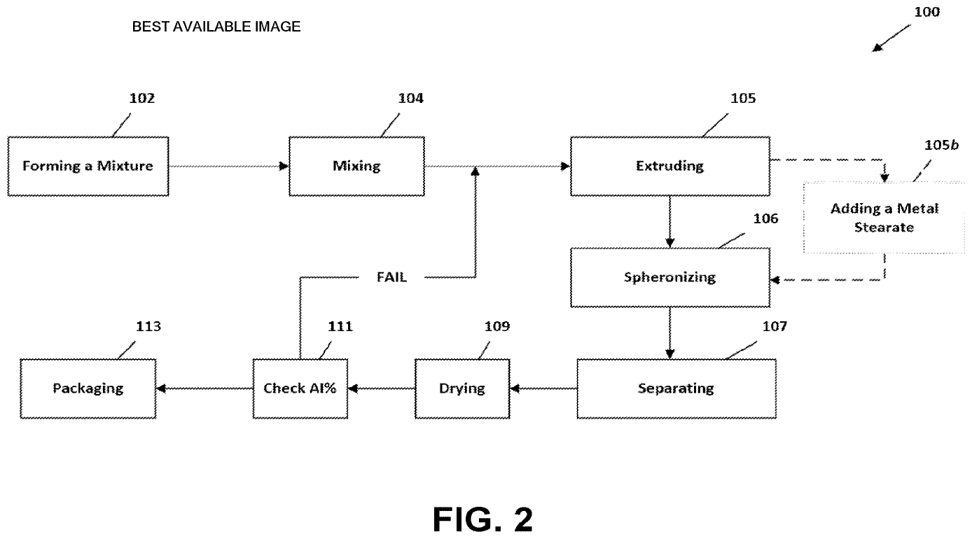

FIG. 2 illustrates an exemplary method 100 for manufacturing exemplary insecticidal compositions. As shown in FIG. 2, in various instances, method 100 comprises forming a mixture (operation 102), mixing the mixture (operation 104), extruding the mixture (operation 105), spheronizing the extruded material to form granules (operation 106), separating the granules having a diameter from 1.4 mm to 3.4 mm (operation 107), drying the granules having an average diameter of 1.4 mm to 3.4 mm (operation 109), checking the active ingredient percent (AI %) in the dried granules for quality control (operation 111), and packaging the granules that pass the AI % check (operation 113). Exemplary optional operations are shown in in dotted outline in FIG. 2. Other embodiments may include more or fewer operations.

An exemplary method may begin by combining various constituents in an appropriate vessel to form a mixture (operation 102). Exemplary constituents are described in greater detail above and may include a spinosyn-based active ingredient, a plaster, a polyethylene glycol, and water. In some instances, exemplary constituents may optionally further include a wax and/or a gum. The exemplary constituents may be blended in varying order. In various instances, the constituents may be in powder form.

Exemplary methods may further comprise mixing the mixture in the vessel (operation 104). Different equipment may be used for mixing. Exemplary mixing equipment may include blenders, paddle blenders, ribbon blenders, agitators, and extruders.

In some instances, forming the mixture in the vessel (operation 102) and mixing the mixture in the vessel (operation 104) may occur concurrently. In other instances, forming the mixture in the vessel (operation 102) and mixing the mixture in the vessel (operation 104) may occur sequentially.

In various instances, while forming the mixture in the vessel (operation 102) and/or mixing the mixture in the vessel (operation 104), the vessel's temperature may be regulated using an exemplary temperature regulation device.

In various instances, the vessel may be maintained at a temperature of 20° C. to 30° C. In various instances, the vessel may be maintained at a temperature of 21° C. to 29° C.; 22° C. to 28° C.; 23° C. to 27° C.; or 24° C. to 26° C. In various instances, the vessel may be maintained at a temperature of no greater than 30° C.; no greater than 29° C.; no greater than 28° C.; no greater than 27° C.; no greater than 26° C.; no greater than 25° C.; no greater than 24° C.; no greater than 23° C.; no greater than 22° C.; no greater than 21° C.; or no greater than 20° C. In various instances, the vessel may be maintained at a temperature of no less than 20° C.; no less than 21° C.; no less than 22° C.; no less than 23° C.; no less than 24° C.; no less than 25° C.; no less than 26° C.; no less than 27° C.; no less than 28° C.; no less than 29° C.; or no less than 30° C.

Mixing exemplary mixtures (operation 104) may occur for a period of 20 minutes to 60 minutes. In various instances, mixing exemplary mixtures may occur for a period of 23 minutes to 57 minutes; 25 minutes to 55 minutes; 28 minutes to 52 minutes; 30 minutes to 50 minutes; 33 minutes to 47 minutes; 35 minutes to 45 minutes; or 37 minutes to 43 minutes. In various instances, mixing exemplary mixtures may occur for a period of no greater than 60 minutes; no greater than 55 minutes; no greater than 50 minutes; no greater than 45 minutes; no greater than 40 minutes; no greater than 35 minutes; no greater than 30 minutes; no greater than 25 minutes; or no greater than 23 minutes. In various instances, mixing exemplary mixtures may occur for a period of no less than 20 minutes; no less than 25 minutes; no less than 30 minutes; no less than 35 minutes; no less than 40 minutes; no less than 45 minutes; no less than 50 minutes; no less than 55 minutes; or no less than 57 minutes.

After mixing, the mixture may then be extruded to form an extruded material (operation 105). Resulting extrusions may have various shapes, such as cylinders. In various instances, the mixture may be extruded to form extruded pellets. Various extruders known in the art may be used.

Extruding exemplary mixtures may occur at a temperature of 20° C. to 30° C. In various instances, extruding exemplary mixtures may occur at a temperature of 21° C. to 29° C.; 22° C. to 28° C.; 23° C. to 27° C.; or 24° C. to 26° C. In various instances, extruding exemplary mixtures may occur at a temperature of no greater than 30° C.; no greater than 29° C.; no greater than 28° C.; no greater than 27° C.; no greater than 26° C.; no greater than 25° C.; no greater than 24° C.; no greater than 23° C.; no greater than 22° C.; no greater than 21° C.; or no greater than 20° C. In various instances, extruding exemplary mixtures may occur at a temperature of no less than 20° C.; no less than 21° C.; no less than 22° C.; no less than 23° C.; no less than 24° C.; no less than 25° C.; no less than 26° C.; no less than 27° C.; no less than 28° C.; no less than 29° C.; or no less than 30° C.

Extruding exemplary mixtures may occur at an output rate of 6 kg/hour to 12 kg/hour. In various instances, extruding exemplary mixtures may occur at an output rate of 7 kg/hour to 12 kg/hour; 7 kg/hour to 11 kg/hour; 8 kg/hour to 11 kg/hour; 8 kg/hour to 10 kg/hour; or 9 kg/hour to 10 kg/hour. In various instances, extruding exemplary mixtures may occur at an output rate of no greater than 12 kg/hour; no greater than 11 kg/hour; no greater than 10 kg/hour; no greater than 9 kg/hour; no greater than 8 kg/hour; or no greater than 7 kg/hour. In various instances, extruding exemplary mixtures may occur at an output rate of no less than 6 kg/hour; no less than 7 kg/hour; no less than 8 kg/hour; no less than 9 kg/hour; no less than 10 kg/hour; or no less than 11 kg/hour.

Optionally, in some implementations, after extruding the mixture (operation 105), a metal stearate may be added to the extruded material (operation 105b).

In various instances, the metal stearate may be added in the form of a powder. In some instances, the metal stearate may be added to the extruded material by cascading the metal stearate onto the extruded material. In various instances, while cascading the metal stearate onto the extruded material, the extruded material may be moving on a conveyor. In other instances, the metal stearate may be added to a hopper containing the extruded material. In various instances, while adding the metal stearate to the hopper containing the extruded material, the hopper may be agitated.

Then, the extruded material or the extruded material with metal stearate may be spheronized to form granules (operation 106). Spheronization may be performed using a granulator, a spheronizer, and/or a chopper unit. In various instances, the spheronizer may be a Marumerizer™ spheronizer.

Next, the resulting granules from the spheronization may be separated to narrow the particle size distribution (operation 107). Granules having an average diameter between 1.4 mm to 3.4 mm may be separated.

After the separation of granules having an average diameter from 1.4 mm to 3.4 mm, the granules may be dried (operation 109). In various instances, only the granules having an average diameter from 1.4 mm to 3.4 mm may be provided to the drying operation (operation 109).

In various instances, 75% to 85% of the granules provided to the drying operation have an average diameter of 2.4 mm to 3.4 mm. In various instances, 75% to 85% of the granules provided to the drying operation have an average diameter of 2.4 to 3.4 mm. In various instances, 76% to 84%; 77% to 83%; 78% to 82%; or 79% to 81% of the granules provided to the drying operation have an average diameter of 2.4 mm to 3.4 mm. In various instances, no greater than 85%; no greater than 82%; no greater than 80%; no greater than 77%; or no greater than 75% of the granules provided to the drying operation have an average diameter of 2.4 mm to 3.4 mm. In various instances, no less than 75%; no less than 77%; no less than 80%; no less than 82%; or no less than 85% of the granules provided to the drying operation have an average diameter of 2.4 mm to 3.4 mm.

Drying the granules may occur at a temperature of 20° C. to 40° C. In various instances, drying the granules may occur at a temperature of 21° C. to 39° C.; 22° C. to 38° C.; 23° C. to 37° C.; 24° C. to 36° C.; 25° C. to 35° C.; 26° C. to 34° C.; 27° C. to 33° C.; 28° C. to 32° C.; or 29° C. to 31° C. In various instances, drying the granules may occur at a temperature of no greater than 40° C.; no greater than 37° C.; no greater than 35° C.; no greater than 33° C.; no greater than 30° C.; no greater than 28° C.; no greater than 25° C.; or no greater than 23° C. In various instances, drying the granules may occur at a temperature of no less than 20° C.; no less than 22° C.; no less than 25° C.; no less than 27° C.; no less than 30° C.; no less than 32° C.; no less than 35° C.; or no less than no less than 37° C.

Drying the granules may occur for a period of 60 minutes to 120 minutes. In various instances, drying the granules may occur for a period of 65 minutes to 115 minutes; 70 minutes to 110 minutes; 75 minutes to 105 minutes; 80 minutes to 100 minutes; 85 minutes to 95 minutes; or 85 minutes to 90 minutes. In various instances, drying the granules may occur for a period of no greater than 120 minutes; no greater than 115 minutes; no greater than 110 minutes; no greater than 105 minutes; no greater than 100 minutes; no greater than 95 minutes; no greater than 90 minutes; no greater than 85 minutes; no greater than 80 minutes; no greater than 75 minutes; no greater than 70 minutes; or no greater than 65 minutes. In various instances, drying the granules may occur for a period of no less than 60 minutes; no less than 65 minutes; no less than 70 minutes; no less than 75 minutes; no less than 80 minutes; no less than 85 minutes; no less than 90 minutes; no less than 95 minutes; no less than 100 minutes; no less than 105 minutes; no less than 110 minutes; or no less than 115 minutes.

After drying, exemplary dried granules may have a moisture content of 0.5 wt % to 13.5 wt %. In various instances, after drying, exemplary dried granules may have a moisture content of 1 wt % to 13 wt %; 2 wt % to 12 wt %; 3 wt % to 11 wt %; 4 wt % to 10 wt %; 5 wt % to 9 wt %; or 6 wt % to 8 wt %. In various instances, after drying, exemplary dried granules may have a moisture content of no greater than 13.5 wt %; no greater than 13 wt %; no greater than 12 wt %; no greater than 11 wt %; no greater than 10 wt %; no greater than 9 wt %; no greater than 8 wt %; no greater than 7 wt %; no greater than 6 wt %; no greater than 5 wt %; no greater than 4 wt %; no greater than 3 wt %; no greater than 2 wt %; or no greater than 1 wt %. In various instances, after drying, exemplary dried granules may have a moisture content of no less than 1 wt %; no less than 2 wt %; no less than 3 wt %; no less than 4 wt %; no less than 5 wt %; no less than 6 wt %; no less than 7 wt % no less than 8 wt %; no less than 9 wt %; no less than 10 wt %; no less than 11 wt %; no less than 12 wt %; or no less than 13 wt %.

After drying, exemplary dried granules may also have a pour density of 880 to 1360 kilograms per cubic meter (kg/m³). In various instances, after drying, exemplary dried granules may have a pour density of 900 to 1350 kg/m³; 910 to 1330 kg/m³; 930 to 1310 kg/m³; 950 to 1300 kg/m³; 960 to 1280 kg/m³; 980 to 1270 kg/m³; 990 to 1250 kg/m³; 1010 to 1230 kg/m³; 1030 to 1220 kg/m³; 1040 to 1200 kg/m³; 1060 to 1170 kg/m³; 1070 to 1120 kg/m³; or 1080 to 1100 kg/m³. In various instances, after drying, exemplary dried granules may have a pour density of no greater than 1360 kg/m³; no greater than 1330 kg/m³; no greater than 1280 kg/m³; no greater than 1250 kg/m³; no greater than 1200 kg/m³; no greater than 1170 kg/m³; no greater than 1120 kg/m³; no greater than 1090 kg/m³; no greater than 1040 kg/m³; no greater than 1010 kg/m³; no greater than 960 kg/m³; no greater than 930 kg/m³; or no greater than 900 kg/m³. In various instances, after drying, exemplary dried granules may have a pour density of no less than 880 kg/m³; no less than 910 kg/m³; no less than 960 kg/m³; no less than 990 kg/m³; no less than 1040 kg/m³; no less than 1070 kg/m³; no less than 1100 kg/m³; no less than 1120 kg/m³; no less than 1150 kg/m³; no less than 1200 kg/m³; no less than 1250 kg/m³; no less than 1230 kg/m³; no less than 1280 kg/m³; no less than 1310 kg/m³; or no less than 1330 kg/m³.

Then the dried granules may undergo an active ingredient percent (AI %) check to verify that the spinosyn-based active ingredient, is present in the granules within a predetermined range. The active ingredient percent (AI %) may be evaluated using High Performance Liquid Chromatography (HPLC). As an example, a predetermined weight percent range may be 0.25 wt % to 3.50 wt %. The granules that pass the AI % check may be packaged (operation 113).

### IV. EXEMPLARY METHODS OF USING EXEMPLARY INSECTICIDAL COMPOSITIONS

Exemplary insecticidal compositions disclosed and contemplated herein may be used in methods for pest control. For instance, exemplary insecticidal compositions may be placed in aqueous media, such as bodies of water. Exemplary compositions may also be placed in an area that is intermittently wet. Examples of application sites include marine and freshwater aquatic environments, storm water drainage areas, sewers and catch basins, woodland pools, snow pools, roadside ditches, retention ponds, freshwater dredge spoils, tire tracks, rock holes, pot holes and similar areas subject to holding water; natural and manmade aquatic sites, fish ponds, ornamental ponds and fountains, other artificial water-holding containers or tanks, flooded crypts, transformer vaults, abandoned swimming pools, construction and other natural or manmade depressions, stream eddies, creek edges, and detention ponds; freshwater swamps and marshes including mixed hardwood swamps, cattail marsh, common reed wetland, water hyacinth ponds, and similar freshwater areas with emergent vegetation; brackish water swamps and marshes, intertidal areas; sewage effluent, sewers, sewage lagoons, cesspools, oxidation ponds, septic ditches and tanks, animal waste lagoons and settling ponds, livestock runoff lagoons, wastewater impoundments associated with fruit and vegetable processing, and similar areas. Other examples include, without limitation, dormant rice fields (for application during the interval between harvest and preparation of the field for the next cropping cycle), and in standing water within pastures/hay fields, rangeland, orchards, and citrus groves where mosquito breeding occurs.

Exemplary insecticidal compositions may release an effective amount of the spinosyn-based active ingredient within the first 24 hours. The term “effective amount,” as used herein, refers to an amount sufficient to achieve a target mosquito mortality efficacy. The target mosquito mortality efficacy may be a percent (%) mosquito mortality within a particular period. In some instances, the target mosquito efficacy may be ≥90% mosquito mortality within 96 hours. In some instances, the target mosquito efficacy may be ≥90% mosquito mortality within 72 hours.

Exemplary insecticidal compositions may provide an extended release of the spinosyn-based active ingredient. As used herein, the term “extended-release composition” or “extended release” means that the release of spinosyn-based active ingredient from the tablet when the tablet is placed in water may occur over periods of at least about 30 days, at least about 60 days, at least about 90 days, or at least about 150 days. In various instances, exemplary insecticidal compositions may provide an extended release of the spinosyn-based active ingredient over a period of 30 days to 150 days. In various instances, exemplary insecticidal compositions may provide an extended release of the spinosyn-based active ingredient over a period of 40 days to 150 days; 45 days to 145 days; 50 days to 140 days; 55 days to 135 days; 60 days to 130 days; 65 days to 125 days; 70 days to 120 days; 75 days to 115 days; 80 days to 110 days; 85 days to 105 days; or 90 days to 100 days. In various instances, exemplary insecticidal compositions may provide an extended release of the spinosyn-based active ingredient over a period of no greater than 150 days; no greater than 140 days; no greater than 130 days; no greater than 120 days; no greater than 110 days; no greater than 100 days; no greater than 90 days; no greater than 80 days; no greater than 70 days; no greater than 60 days; no greater than 50 days; or no greater than 40 days. In various instances, exemplary insecticidal compositions may provide an extended release of the spinosyn-based active ingredient over a period of no less than 30 days; no less than 40 days; no less than 50 days; no less than 60 days; no less than 70 days; no less than 80 days; no less than 90 days; no less than 100 days; no less than 110 days; no less than 120 days; no less than 130 days; or no less than 140 days.

### V. EXPERIMENTAL EXAMPLES

Without limiting the scope of the instant disclosure, various experimental examples of embodiments discussed above were prepared and the results are discussed below.

### Example 1: Efficacy Studies

### A. Introduction

An objective of the following studies was to determine the potential of spheronized granules comprising spinetoram as mortality agents for up to 40 days against three different larvae species: Aedes aegypti (ROCK strain), Culex quinquefasciatus, and Anopheles quadrimaculatus, with output recorded weekly as percent mortality at 24, 48, and 72 hours. Ideally, the EPA threshold of ≥90% mortality within 72 hours is achieved. Of note, the first week (i.e., week 1) is an exception where the EPA's threshold of ≥90% mortality is extended to 96 hours.

### B. Study 1: Efficacy of Granules Prepared According to a First Lab-Scale Manufacturing Process

The first study, Study 1, was conducted to evaluate three different spinetoram multi-brood granule (MBG) prototypes: MBG-1, MBG-2, and MBG-3, which were prepared according to a first lab-scale manufacturing process. Below is a summary of the study parameters along with the 72-hour (percent (%) mortality at 72 hours) efficacy results on three different species of larvae: Aedes aegypti, Culex quinquefasciatus, and Anopheles quadrimaculatus, for a six-week period. The first week (week 1) was the only week where the efficacy results were presented at 96-hours, rather than 72-hours, as allowed by the EPA guidelines. Study 1 is summarized by Table 1, shown below.

TABLE 1
Summary of Study 1.

| | |
|---|---|
| Purpose | To determine the efficacy of three different prototypes of |
| | spheronized granules comprising spinetoram (MBG-1, MBG-2, and |
| | MBG-3) against Aedes aegypti, Culex quinquefasciatus and |
| | Anopheles quadrimaculatus in extended week study for a period of |
| | 6-weeks in 17-liter (17 L) containers. |
| | MBG 1: CMP128-029 (0.36% by weight spinetoram, 9% by weight |
| | PEG, 15% by weight water, and 75.60% by weight plaster), average |
| | diameter of 1.5 mm |
| | MBG2: CMP128-028 (0.36% by weight spinetoram, 11% by weight |
| | PEG, 13.5% by weight water, and 75.14% by weight plaster), |
| | average diameter of 2 mm |
| | MBG 3: CMP128-028 (0.36% by weight spinetoram, 9% by weight |
| | PEG, 13.5% by weight water, and 75.14% by weight plaster), |
| | average diameter of 1.5 mm |
| Hypothesis | Spheronized granules with an appropriate amount of PEG and |
| | extrusion size can be efficacious for 6-weeks in containers with 17 L |
| | of water. |
| What was | Efficacy (72-hr mortality (96-hr mortality for week 1)) was |
| Measured/Monitored | measured by removing the larvae from the containers and |
| | having a scientist visually observe and count how many |
| | larvae are dead or alive at the specified timepoint. |
| | Granule breakdown pattern was assessed by a scientist |
| | visually observing the granules (qualitative measurement). |
| | pH was measured using a digital pH meter and/or pH strips. |
| | Temperature was measured using a NIST certified digital |
| | thermometer with an external probe placed into the water for |
| | water temperature readings and an internal probe for air |
| | temperature readings. |
| Controls | Volume of water (17 L), |
| | Water exchange (0%) i.e., a zero-water exchange system¹ |
| | ¹In a zero-water exchange system, no water is removed from the |
| | system and no water is added after the system is initially filled. |
| Variables | Granule PEG content (9% and 11% by weight), |
| | Extrusion size (average diameter of 1.5 mm and 2 mm) |
| Method | Larval Bioassay-Buckets |
| | 17 L water in Buckets |
| | Each prototype with 4 replicates of 25 larvae each |
| | (n = 50) |
| | 1/32 teaspoon Tetra Fin ® (Aedes aegypti & Culex |
| | quinquefasciatus), 1/32 teaspoon Tetra Fin ® food slurry |
| | (Anopheles quadrimaculatus) |
| | The granule quantity for addition to the buckets was determined by |
| | the intended application rate, 5 lb/acre. Based on the granule's active |
| | ingredient concentration, this rate translates to adding approximately |
| | 100 mg of granules to each bucket when at a volume of 17 liters. |
| | The % mortality was determined by counting how many larvae were |
| | alive and dead at each time point. This number was subtracted from |
| | the total number of larvae in each bucket before the study began. |
| | For each study, water evaporation was prevented by placing plastic |
| | shower caps over the top of each bucket. These shower caps were |
| | only removed to conduct the mortality readings at each time point |
| | (24, 48, 72 and 96 hours). |

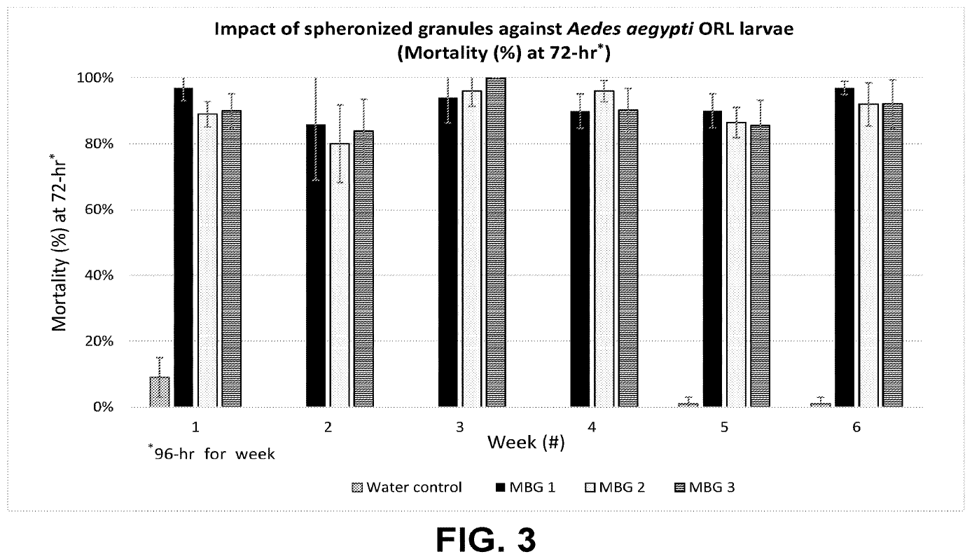

FIGS. 3-5 show the 72-hour (hr) efficacy results (percent (%) mortality at 72-hr (96-hr for week 1)) against Aedes aegypti, Culex quinquefasciatus, and Anopheles quadrimaculatus larvae over a 6-week period for the three experimental spinetoram granule prototypes: MBG-1, MBG-2, and MBG-3, which were prepared according to the first lab-scale manufacturing process. *96-hours for week 1.

FIG. 3 graphically shows the 72-hour (hr) efficacy results (percent (0%) mortality at 72-hours*) against Aedes aegypti larvae over a 6-week period for MBG-1, MBG-2, and MBG-3 (experimental prototypes), which were prepared according to the first lab-scale manufacturing process. *96-hours for week 1. The 6-week efficacy data for Aedes aegypti is summarized in Table 2, below.

TABLE 2
6-week efficacy data for Aedes aegypti for the granules prepared
according to the first lab-scale manufacturing process.
Aedes aegypti - Mortality Results at 72-hours (96-hours for Week 1)

| | Week 1 | Week 2 | Week 3 | Week 4 | Week 5 | Week 6 |
|---|---|---|---|---|---|---|
| Prototype | Mortality (%) after 72 hours (after 96-hours for week 1) | | | | | |
| Water | 9% | 0% | 0% | 0% | 1% | 1% |
| control | | | | | | |
| MBG-1 | 97% | 86% | 94% | 90% | 90% | 97% |
| MBG-2 | 89% | 80% | 96% | 96% | 86% | 92% |
| MBG-3 | 90% | 84% | 100% | 90% | 86% | 92% |

Aedes aegypti - Standard Deviation at 72-hours (96-hours for Week 1)

| | Week 1 | Week 2 | Week 3 | Week 4 | Week 5 | Week 6 |
|---|---|---|---|---|---|---|
| Prototype | Mortality (%) after 72 hours (after 96-hours for week 1) | | | | | |
| Water | 6% | 0% | 0% | 0% | 2% | 2% |
| control | | | | | | |
| MBG-1 | 4% | 17% | 8% | 5% | 5% | 2% |
| MBG-2 | 4% | 12% | 5% | 3% | 5% | 7% |
| MBG-3 | 5% | 10% | 0% | 7% | 8% | 7% |

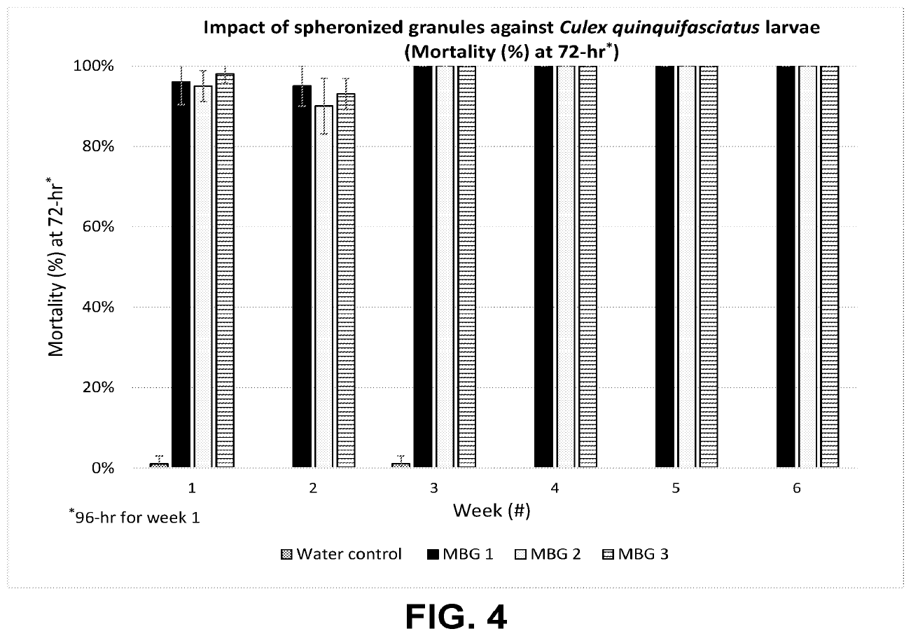

FIG. 4 graphically shows the 72-hour (hr) efficacy results (percent (0%) mortality at 72-hours) against Culex quinquefasciatus larvae over a 6-week period for M WBG-1, BG-2, and MBG-3 (experimental prototypes), which were prepared according to the first lab-scale manufacturing process. *96-hours for week 1. The 6-week efficacy data for Culex quinquefasciatus is summarized in Table 3, below.

TABLE 3
6-week efficacy data for Culex quinquefasciatus for the granules
prepared according to the first lab-scale manufacturing process.
Culex quinquefasciatus - Mortality Results at 72-hours (96-hours for Week 1)

| | Week 1 | Week 2 | Week 3 | Week 4 | Week 5 | Week 6 |
|---|---|---|---|---|---|---|
| Prototype | Mortality (%) after 72 hours (after 96-hours for week 1) | | | | | |
| Water | 1% | 0% | 1% | 0% | 0% | 0% |
| control | | | | | | |
| MBG-1 | 96% | 95% | 100% | 100% | 100% | 100% |
| MBG-2 | 95% | 90% | 100% | 100% | 100% | 100% |
| MBG-3 | 98% | 93% | 100% | 100% | 100% | 100% |

Culex quinquefasciatus - Standard Deviation at 72-hours (96-hours for Week 1)

| | Week 1 | Week 2 | Week 3 | Week 4 | Week 5 | Week 6 |
|---|---|---|---|---|---|---|
| Prototype | Mortality (%) after 72 hours (after 96-hours for week 1) | | | | | |
| Water | 2% | 0% | 2% | 0% | 0% | 0% |
| control | | | | | | |
| MBG-1 | 6% | 5% | 0% | 0% | 0% | 0% |
| MBG-2 | 4% | 7% | 0% | 0% | 0% | 0% |
| MBG-3 | 2% | 4% | 0% | 0% | 0% | 0% |

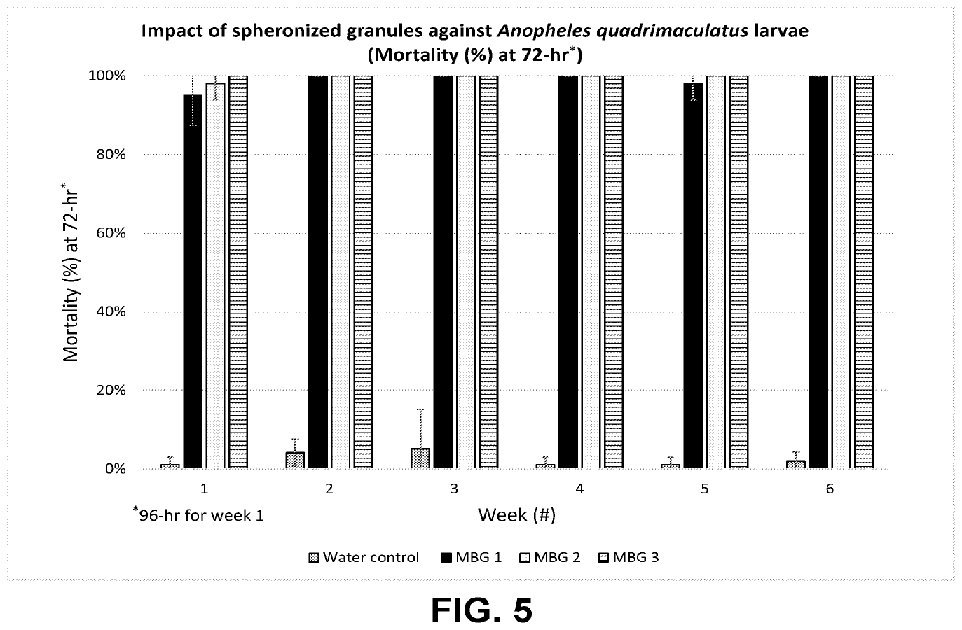

FIG. 5 graphically shows the 72-hour (hr) efficacy results (percent (0%) mortality at 72-hours) against Anopheles quadrimaculatus larvae over a 6-week period for MBG-1, MBG-2, and MBG-3 (experimental prototypes), which were prepared according to the first lab-scale manufacturing process. *96-hours for week 1. The 6-week efficacy data for Anopheles quadrimaculatus is summarized in Table 4, below.

TABLE 4
6-week efficacy data for Anopheles quadrimaculatus for the granules
prepared according to the first lab-scale manufacturing process.
Anopheles quadrimaculatus - Mortality Results at 72-hours (96-hours for Week 1)

| | Week 1 | Week 2 | Week 3 | Week 4 | Week 5 | Week 6 |
|---|---|---|---|---|---|---|
| Prototype | Mortality (%) after 72 hours (after 96-hours for week 1) | | | | | |
| Water | 1% | 4% | 5% | 1% | 1% | 2% |
| control | | | | | | |
| MBG-1 | 95% | 100% | 100% | 100% | 98% | 100% |
| MBG-2 | 98% | 100% | 100% | 100% | 100% | 100% |
| MBG-3 | 100% | 100% | 100% | 100% | 100% | 100% |

Anopheles quadrimaculatus - Standard Deviation at 72-hours (96-hours for Week 1)

| | Week 1 | Week 2 | Week 3 | Week 4 | Week 5 | Week 6 |
|---|---|---|---|---|---|---|
| Prototype | Mortality (%) after 72 hours (after 96-hours for week 1) | | | | | |
| Water | 2% | 3% | 10% | 2% | 2% | 2% |
| control | | | | | | |
| MBG-1 | 8% | 0% | 0% | 0% | 4% | 0% |
| MBG-2 | 4% | 0% | 0% | 0% | 0% | 0% |
| MBG-3 | 0% | 0% | 0% | 0% | 0% | 0% |

The results from the first study showed that Aedes aegypti was the least susceptible species to all the insecticidal granules. MBG-1 granules, which comprised 9% o by weight PEG and had an average diameter of 1.5 mm, were the most effective overall. However, MBG-2 and MBG-3 had diluted AI concentration (0.34% AI by weight) in comparison to MBG-1 (0.3900 AI by weight) which may have resulted in their comparatively lower efficacy. MBG-1, MBG-2, and MBG-3 were all intended to have the same AI concentration, 0.36% by weight. Therefore, the next step was to modify the first lab-scale manufacturing process to avoid this undesirable dilution with future prototypes.

### C. Study 2: Efficacy of Granules Prepared According to a Second Lab-Scale Manufacturing Process

The second study was conducted to evaluate the three different spinetoram granule prototypes, MBG-1, MBG-2, and MBG-3, which were prepared according to a second lab-scale manufacturing process. The second manufacturing process involved: 1) during spheronization, adding AI to the plaster as the plaster was being added onto the granules, and 2) adding less water to the initial formula prior to extrusion.

Below is a summary of the study parameters along with the 72-hour (percent (%) mortality at 72 hours) efficacy results on three different species of larvae: Aedes aegypti, Culex quinquefasciatus, and Anopheles quadrimaculatus, for a six-week period. The first week (week 1) was the only week where the efficacy results were presented at 96-hours, rather than 72-hours, as allowed by the EPA guidelines. Study 2 is summarized by Table 5, shown below.

TABLE 5
Summary of Study 2.

| | |
|---|---|
| Purpose | To determine the efficacy of three different prototypes of spheronized |
| | granules comprising spinetoram (MBG-1, MBG-2, and MBG-3) |
| | against Aedes aegypti, Culex quinquefasciatus and Anopheles |
| | quadrimaculatus in extended week study for a period of 6-weeks in |
| | 17-liter (17 L) containers. |
| | MBG-1: CMP128-030 (0.36% by weight spinetoram, 11% by weight |
| | PEG, 10% by weight water, and 78.84% by weight plaster), average |
| | diameter of 1.5 mm |
| | MBG-2: CMP128-030 (0.36% by weight spinetoram, 11% by weight |
| | PEG, 10% by weight water, and 78.84% by weight plaster), average |
| | diameter of 2 mm |
| | MBG-3: CMP128-031 (0.36% by weight spinetoram, 9% by weight |
| | PEG, 11.8% by weight water, and 78.64% by weight plaster), average |
| | diameter of 1.5 mm |
| Hypothesis | Spheronized granules with an appropriate amount of PEG and |
| | extrusion size can be efficacious for 6-weeks in containers with 17 L of |
| | water. |
| What was | Efficacy (72-hr mortality (96-hr mortality for week 1)) was |
| Measured/Monitored | measured by removing the larvae from the containers and |
| | having a scientist visually observe and count how many larvae |
| | are dead or alive at the specified timepoint. |
| | Granule breakdown pattern was assessed by a scientist visually |
| | observing the granules (qualitative measurement). |
| | pH was measured using a digital pH meter and/or pH strips. |
| | Temperature was measured using a NIST certified digital |
| | thermometer with an external probe placed into the water for |
| | water temperature readings and an internal probe for air |
| | temperature readings. |
| Controls | Volume of water (17 L), |
| | Water exchange (0%) i.e., a zero-water exchange system¹ |
| | ¹In a zero-water exchange system, no water is removed from the system and |
| | no water is added after the system is initially filled. |
| Variables | Granule PEG content (9% and 11% by weight), |
| | Extrusion size (average diameter of 1.5 mm and 2 mm) |
| | Larval Bioassay-Buckets |
| | 17 L water in Buckets |
| | Each prototype with 4 replicates of 25 larvae each |
| | (n = 50) |
| | 1/32 teaspoon Tetra Fin ® |
| | — |
| Method | The granule quantity for addition to the buckets was determined by the |
| | intended application rate, 5 lb/acre. Based on the granule's active |
| | ingredient concentration, this rate translates to adding approximately |
| | 100 mg of granules to each bucket when at a volume of 17 liters. |
| | The % mortality was determined by counting how many larvae were |
| | alive and dead at each time point. This number was subtracted from the |
| | total number of larvae in each bucket before the study began. |
| | For each study, water evaporation was prevented by placing plastic |
| | shower caps over the top of each bucket. These shower caps were only |
| | removed to conduct the mortality readings at each time point |
| | (24, 48, 72 and 96 hours). |

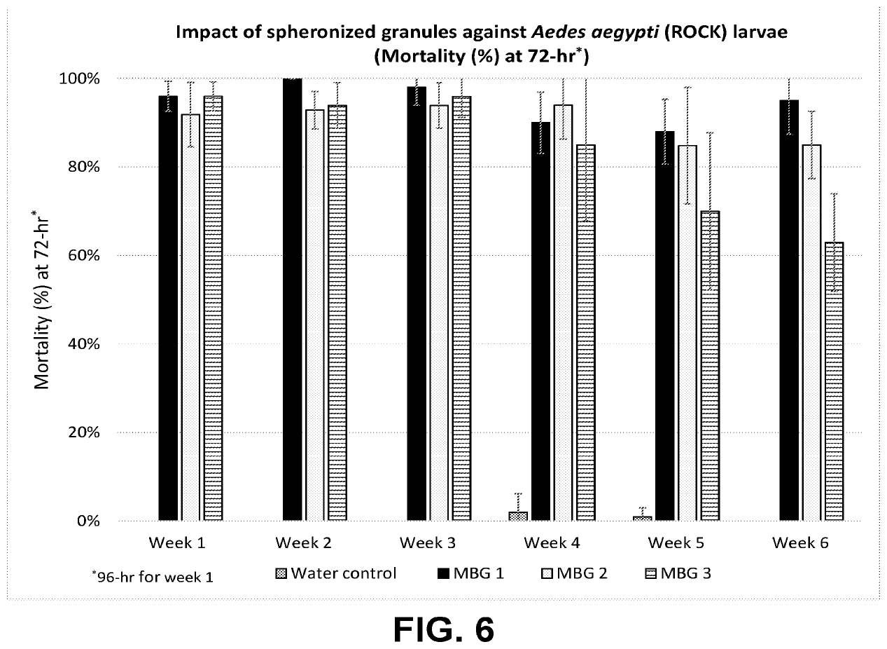

FIGS. 6-8 show the 72-hour (hr) efficacy results (percent (f) mortality at 72-hr (96-hr for week 1)) against Aedes aegypti, Culex quinquefasciatus, and Anopheles quadrimaculatus larvae over a 6-week period for three exemplary granule prototypes: MG-1, MBG-2, and MBG-3, which were prepared according to the second lab-scale manufacturing process.

FIG. 6 graphically shows the 72-hour (hr) efficacy results (percent (0%) mortality at 72-hours*) against Aedes aegypti larvae for MBG-1, MBG-2, and MBG-3 (experimental prototypes), which were prepared according to the second lab-scale manufacturing process. *96-hours for week 1. The 6-week efficacy data for Aedes aegypti is summarized in Table 6, below.

TABLE 6
6-week efficacy data for Aedes aegypti for the granules prepared
according to the second lab-scale manufacturing process.
Aedes aegypti - Mortality (%) at 72-hours (96-hours for Week 1)

| Prototype | Week 1 | Week 2 | Week 3 | Week 4 | Week 5 | Week 6 |
|---|---|---|---|---|---|---|
| Water | 0% | 0% | 0% | 2% | 1% | 0% |
| control | | | | | | |
| MBG-1 | 96% | 100% | 98% | 90% | 88% | 95% |
| MBG-2 | 92% | 93% | 94% | 94% | 85% | 85% |
| MBG-3 | 96% | 94% | 96% | 85% | 70% | 63% |

Aedes aegypti - Standard Deviation at 72-hours (96-hours for Week 1)

| Prototype | Week 1 | Week 2 | Week 3 | Week 4 | Week 5 | Week 6 |
|---|---|---|---|---|---|---|
| Water | 0% | 0% | 0% | 4% | 2% | 0% |
| control | | | | | | |
| MBG-1 | 3% | 0% | 4% | 7% | 7% | 8% |
| MBG-2 | 7% | 4% | 5% | 8% | 13% | 8% |
| MBG-3 | 3% | 5% | 5% | 17% | 18% | 11% |

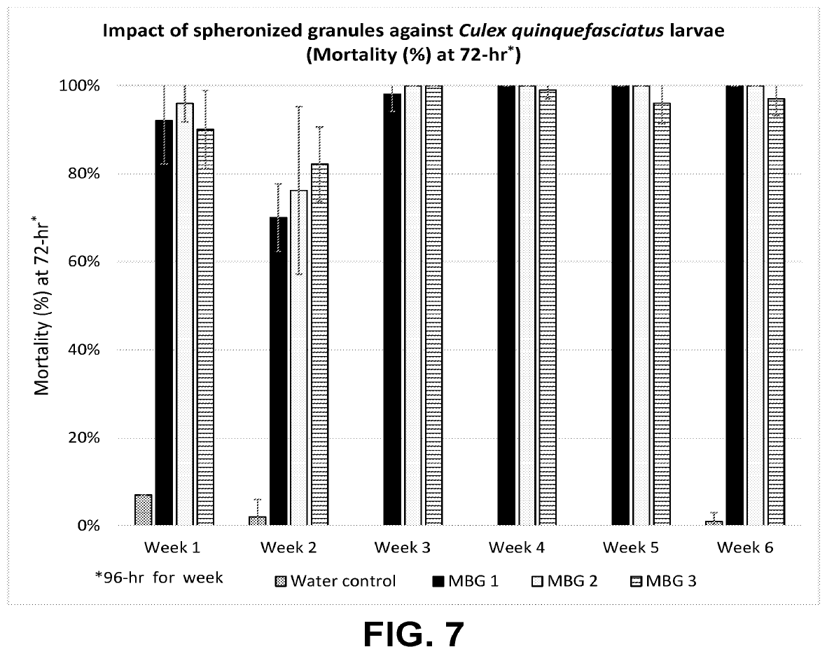

FIG. 7 graphically shows the 72-hour (hr) efficacy results (percent (0%) mortality at 72-hours*) against Culex quinquefasciatus larvae over a 6-week period for MBG-1, MBG-2, and MBG-3 (experimental prototypes), which were prepared according to the second lab-scale manufacturing process. *96 hours for week 1. The 6-week efficacy data for Culex quinquefasciatus is summarized in Table 7, below,

TABLE 7
6-week efficacy data for Culex quinquefasciatus for the granules
prepared according to the second lab-scale manufacturing process.
Culex quinquefasciatus - Mortality (%)at 72-hours (96-hours for Week 1)

| Prototype | Week 1 | Week 2 | Week 3 | Week 4 | Week 5 | Week 6 |
|---|---|---|---|---|---|---|
| MBG-1 | 92% | 70% | 98% | 100% | 100% | 100% |
| MBG-2 | 96% | 76% | 100% | 100% | 100% | 100% |
| MBG-3 | 90% | 82% | 100% | 99% | 96% | 97% |

Culex quinquefasciatus - Standard Deviation at 72-hours (96-hours for Week 1)

| Prototype | Week 1 | Week 2 | Week 3 | Week 4 | Week 5 | Week 6 |
|---|---|---|---|---|---|---|
| Water | 6% | 4% | 0% | 0% | 0% | 2% |
| control | | | | | | |
| MBG-1 | 7% | 8% | 4% | 0% | 0% | 0% |
| MBG-2 | 5% | 19% | 0% | 0% | 0% | 0% |
| MBG-3 | 5% | 8% | 0% | 2% | 5% | 4% |

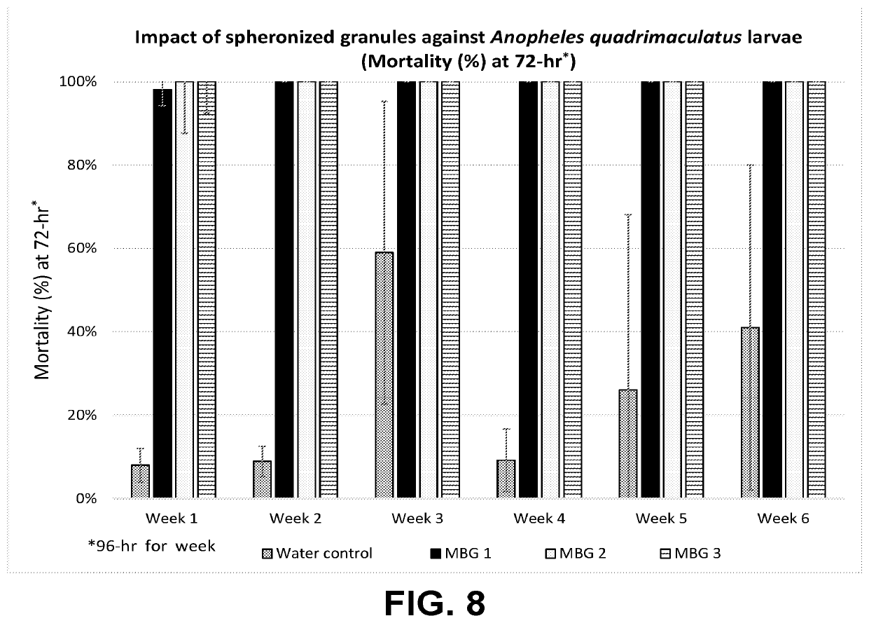

FIG. 8 graphically shows the 72-hour (hr) efficacy results (percent (0%) mortality at 72-hours) against Anopheles quadrimaculatus larvae over a 6-week period for MBG-1, MBG-2, and MBG-3 (experimental prototypes), which were prepared according to the second lab-scale manufacturing process. *96-hours for week 1. The 6-week efficacy data for Anopheles quadrimaculatus is summarized in Table 8, below.

TABLE 8
6-week efficacy data for Anopheles quadrimaculatus for the granules
prepared according to the second lab-scale manufacturing process.
Anopheles quadrimaculatus - Mortality (%) at 72-hours (96-hours for Week 1)

| Prototype | Week 1 | Week 2 | Week 3 | Week 4 | Week 5 | Week 6 |
|---|---|---|---|---|---|---|
| Water | 8% | 9% | 59% | 9% | 26% | 41% |
| control | | | | | | |
| MBG-1 | 98% | 100% | 100% | 100% | 100% | 100% |
| MBG-2 | 100% | 100% | 100% | 100% | 100% | 100% |
| MBG-3 | 100% | 100% | 100% | 100% | 100% | 100% |

Anopheles quadrimaculatus - Standard Deviation at 72-hours (96-hours for Week 1)

| Prototype | Week 1 | Week 2 | Week 3 | Week 4 | Week 5 | Week 6 |
|---|---|---|---|---|---|---|
| Water | 7% | 4% | 36% | 8% | 42% | 39% |
| control | | | | | | |
| MBG-1 | 2% | 0% | 0% | 0% | 0% | 0% |
| MBG-2 | 0% | 0% | 0% | 0% | 0% | 0% |
| MBG-3 | 0% | 0% | 0% | 0% | 0% | 0% |

The results of study 2 confirmed that Aedes aegypti was the least susceptible species to all the insecticidal granules. The results of study 2 further confirmed that the MBG-1 granules, which comprised 11% by weight PEG and had an average diameter of 1.5 mm, were the most effective prototype overall during the 6-week study, particularly again the Aedes aegypti species.

Studies 1 and 2 both demonstrated that spinetoram granules containing 11% by weight PEG performed better than spinetoram granules containing 9% by weight PEG. Studies 1 and 2 demonstrated that spinetoram granules having an extrusion size (average diameter) of 1.5 mm performed better than spinetoram granules having an extrusion size (average diameter) of 2.0 mm.

### Example 2: Metal Stearate Study

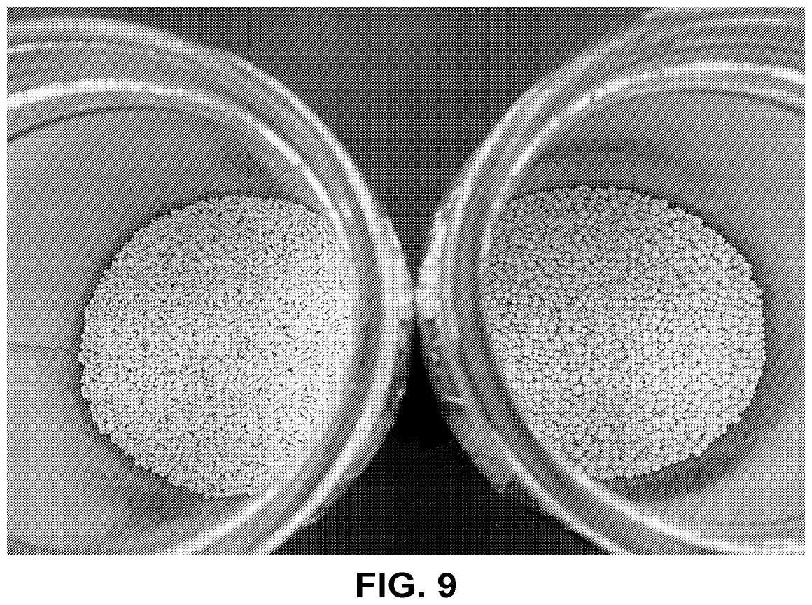

Exemplary insecticidal granules comprising a Spinosad active ingredient, hydrocal X-21 plaster, PEG 8000, and water, were prepared with and without an exemplary metal stearate. Then, the sphericities of the exemplary insecticidal granules prepared with and without the exemplary metal stearate were qualitatively assessed. For this study, magnesium stearate was used as the exemplary metal stearate. As shown in FIG. 9, the exemplary insecticidal granules prepared with the exemplary metal stearate appeared to have a higher sphericity compared to the exemplary insecticidal granules prepared without a metal stearate.

For reasons of completeness, the following Embodiments are provided:

Embodiment 1. An insecticidal composition comprising:
0.25 weight % (wt %) to 3.50 wt % of a spinosyn-based active ingredient;
65 wt % to 85 wt % of a plaster;
7 wt % to 15 wt % of a polyethylene glycol; and
1 wt % to 15 wt % water.
   Embodiment 2. The insecticidal composition of embodiment 1, wherein the plaster comprises a plaster of Paris and further comprising 0.1 wt % to 1.0 wt % of a metal stearate.
   Embodiment 3. The insecticidal composition of embodiment 1 or 2, wherein the polyethylene glycol has a molecular weight of 7500 g/mol to 8500 g/mol; and wherein the metal stearate comprises magnesium stearate.
   Embodiment 4. The insecticidal composition of any one of embodiments 1-3, wherein the polyethylene glycol has a molecular weight of about 8000 g/mol.
   Embodiment 5. The insecticidal composition of any one of embodiments 1-4, wherein the composition comprises 0.30 wt % to 3.00 wt % of the spinosyn-based active ingredient.
   Embodiment 6. The insecticidal composition of any one of embodiments 1-5, wherein the composition comprises 70 wt % to 80 wt % of the plaster.
   Embodiment 7. The insecticidal composition of any one of embodiments 1-6, wherein the composition comprises 9 wt % to 13 wt % of the polyethylene glycol.
   Embodiment 8. The insecticidal composition of any one of embodiments 1-7, wherein the composition comprises 4 wt % to 12 wt % water.
   Embodiment 9. An insecticidal granule comprising:
an insecticidal composition comprising:
   0.30 weight % (wt %) to 3.00 wt % of a spinosyn-based active ingredient;
   70 wt % to 80 wt % of a plaster;
   9 wt % to 13 wt % of a polyethylene glycol; and
   4 wt % to 12 wt % water.
      Embodiment 10. The insecticidal granule of embodiment 9, wherein the plaster comprises a plaster of Paris and further comprising 0.1 wt % to 1.0 wt % of a metal stearate.
      Embodiment 11. The insecticidal granule of embodiment 9 or 10, wherein the polyethylene glycol has a molecular weight of 7500 g/mol to 8500 g/mol; and
wherein the metal stearate comprises magnesium stearate.
   Embodiment 12. The insecticidal granule of any one of embodiments 9-11, wherein the insecticidal granule is in the form of a pellet.
   Embodiment 13. The insecticidal granule of any one of embodiments 9-12, wherein the granule provides an extended release of the spinosyn-based active ingredient over a period of 30 days to 150 days.
   Embodiment 14. A method of controlling pests at an application site, the method comprising applying the insecticidal granule according to any one of embodiments 9-13 to the application site.
   Embodiment 15. The method of embodiment 14, wherein the method comprises placing the granule in water.
   Embodiment 16. The method of embodiment 14 or 15, wherein the pests comprise mosquitoes.
   Embodiment 17. A method of making an insecticidal granule, the method comprising:
forming a mixture comprising:
   0.25 weight % (wt %) to 3.50 wt % of a spinosyn-based active ingredient;
   65 wt % to 85 wt % of a plaster;
   7 wt % to 15 wt % of a polyethylene glycol; and
   1 wt % to 15 wt % water;
mixing the mixture;
extruding the mixture to form an extruded material;
spheronizing the extruded mixture to form granules; and
drying the granules to produce dried granules.
   Embodiment 18. The method of embodiment 17, wherein extruding occurs at a temperature of 20° C. to 30° C. at an output rate of 6 kg/hour to 12 kg/hour.
   Embodiment 19. The method of embodiment 17 or 18, further comprising after forming the granules, and before drying the granules, separating granules having an average diameter of 1.4 mm to 3.4 mm; and
providing only the granules having an average diameter of 1.4 mm to 3.4 mm to the drying operation.
   Embodiment 20. The method of embodiment 19, wherein 75 wt % to 85 wt % of the provided granules have an average diameter of 2.4 mm to 3.4 mm.
   Embodiment 21. The method of any one of embodiments 17-20, wherein drying the granules occurs at a temperature of 20° C. to 40° C. for a period of 60 minutes to 120 minutes.
   Embodiment 22. The method of any one of embodiments 17-21, wherein the dried granules have a moisture content of 0.5 to 13.5 wt %.
   Embodiment 23. The method of any one of embodiments 17-22, wherein the dried granules have a pour density of 880 to 1360 kilograms per cubic meter (kg/m³).
   Embodiment 24. A method of using a composition for controlling pests, the method comprising:
positioning the composition in a body of water, the composition comprising:
   0.25 weight % (wt %) to 3.50 wt % of a spinosyn-based active ingredient;
   65 wt % to 85 wt % of a plaster;
   7 wt % to 15 wt % of a polyethylene glycol; and
   1 wt % to 15 wt % water.
      Embodiment 25. The method of embodiment 24, wherein the pests comprise mosquitoes.

1. An insecticidal composition comprising:
0.25 weight % (wt %) to 3.50 wt % of a spinosyn-based active ingredient;
65 wt % to 85 wt % of a plaster;
7 wt % to 15 wt % of a polyethylene glycol; and
1 wt % to 15 wt % water.

2. The insecticidal composition of claim 1, wherein the plaster comprises a plaster of Paris; and further comprising 0.1 wt % to 1.0 wt % of a metal stearate.

3. The insecticidal composition of claim 2, wherein the polyethylene glycol has a molecular weight of 7500 g/mol to 8500 g/mol; and
wherein the metal stearate comprises magnesium stearate.

4. The insecticidal composition of claim 3, wherein the polyethylene glycol has a molecular weight of about 8000 g/mol.

5. The insecticidal composition of claim 1, wherein the composition comprises 0.30 wt % to 3.00 wt % of the spinosyn-based active ingredient.

6. The insecticidal composition of claim 1, wherein the composition comprises 70 wt % to 80 wt % of the plaster.

7. The insecticidal composition of claim 1, wherein the composition comprises 9 wt % to 13 wt % of the polyethylene glycol.

8. The insecticidal composition of claim 1, wherein the composition comprises 4 wt % to 12 wt % water.

9-11. (canceled)

12. The insecticidal composition of claim 9, wherein the insecticidal composition is in a form of a granule; and
wherein the granule provides an extended release of the spinosyn-based active ingredient over a period of 30 days to 150 days.

13. (canceled)

14. A method of controlling pests at an application site, the method comprising applying the insecticidal granule according to claim 12 to the application site.

15. The method of claim 14, wherein the method comprises placing the granule in water; and
wherein the pests comprise mosquitoes.

16. (canceled)

17. A method of making an insecticidal granule, the method comprising:
forming a mixture comprising:
0.25 weight % (wt %) to 3.50 wt % of a spinosyn-based active ingredient;
65 wt % to 85 wt % of a plaster;
7 wt % to 15 wt % of a polyethylene glycol; and
1 wt % to 15 wt % water;
mixing the mixture;
extruding the mixture to form an extruded material;
spheronizing the extruded mixture to form granules; and
drying the granules to produce dried granules.

18. The method of claim 17, wherein extruding occurs at a temperature of 20° C. to 30° C. at an output rate of 6 kg/hour to 12 kg/hour.

19. The method of claim 17, further comprising after forming the granules, and before drying the granules, separating granules having an average diameter of 1.4 mm to 3.4 mm; and
providing only the granules having an average diameter of 1.4 mm to 3.4 mm to the drying operation.

20. The method of claim 19, wherein 75 wt % to 85 wt % of the provided granules have an average diameter of 2.4 mm to 3.4 mm.

21. The method of claim 17, wherein drying the granules occurs at a temperature of 20° C. to 40° C. for a period of 60 minutes to 120 minutes.

22. The method of claim 17, wherein the dried granules have a moisture content of 0.5 to 13.5 wt %.

23. The method of claim 17, wherein the dried granules have a pour density of 880 to 1360 kilograms per cubic meter (kg/m³).

24. A method of using a composition for controlling pests, the method comprising:
positioning the composition in a body of water, the composition comprising:
0.25 weight % (wt %) to 3.50 wt % of a spinosyn-based active ingredient;
65 wt % to 85 wt % of a plaster;
7 wt % to 15 wt % of a polyethylene glycol; and
1 wt % to 15 wt % water.

25. The method of claim 24, wherein the pests comprise mosquitoes.
